(19) United States
(12) Patent Application Publication
(10) Pub. No.: US 2016/0370939 A1
(43) Pub. Date: Dec. 22, 2016

(54) Capacitive Sensing Device, Touch Screen and Electronic Equipment

(71) Applicants: SHENZHEN CHINA STAR OPTOELECTRONICS TECHNOLOGY CO., LTD., Shenzhen City, Guangdong (CN); WUHAN CHINA STAR OPTOELECTRONICS TECHNOLOGY CO., LTD., Wuhan, Hubei (CN)

(72) Inventors: Xingling GUO, Shenzhen, Guangdong (CN); Yao-li HUANG, Shenzhen, Guangdong (CN); Man LI, Shenzhen, Guangdong (CN)

(21) Appl. No.: 14/646,018

(22) PCT Filed: Feb. 28, 2015
(86) PCT No.: PCT/CN2015/073407

§ 371 Date: May 19, 2015

(30) Foreign Application Priority Data
Feb. 5, 2015 (CN) 201510065054.0

(51) Int. Cl. G06F 3/041; G06F 3/044

(52) U.S. Cl. CPC G06F 3/0418; G06F 3/044; G06F 2203/04111; G06F 2203/04104

(57) ABSTRACT

A capacitive sensing device, a touch screen, and an electronic equipment are disclosed. The capacitive sensing device includes a first conductive line extended along a first direction and a second conductive line extended along a second direction. The first conductive line is insulated from the second conductive line and the first conductive line and the second conductive line are disposed in an overlapping manner. The first conductive line includes first sensing electrodes and a first connecting bridge. The second conductive line includes second sensing electrodes and a second connecting bridge. The second connecting bridges bypass the first connecting bridges to avoid a short circuit or an open circuit in overlapping portions because of an electrostatic discharge. The first and second connecting bridges are smooth conductive lines. The present invention effectively reduces a probability of occurrence of electrostatic discharge, and is also simple and the transmittance is also higher.

### BACKGROUND OF THE INVENTION

1. Field of the Invention

The present invention relates to a capacitive sensing technology, more particularly, to a capacitive sensing device, a touch Screen and electronic equipment.

2. Description of the Related Art

Touch screens, serving as one kind of input medium, are the simplest and most convenient and natural human-computer means of interaction. Depending on the working principle and medium for detecting the touch information, touch screens can be divided into four types including a resistive type, a capacitive type, an infrared type and a surface acoustic wave type. Among all of them, mutual capacitive touch screens have good inhibitory effects on noises and a parasitic capacitance to ground, and are able to realize multi-type operations, thus becoming a main area that various capacitive touch screen manufacturers devote their efforts to.

Capacitive sensor patterns are utilized in a capacitive sensing device. FIG. 1 is a schematic diagram showing a structure of a capacitive sensing device according to the prior art. As shown in FIG. 1, generally a first conductive line 1 and a second conductive line 2 that are both transparent and respectively arranged in a horizontal direction and a vertical direction are overlapped to form diamond-like shapes. Since signals transmitted by the first conductive line 1 and the second conductive line 2 are different, the first conductive line 1 is not allowed to be short circuited to the second conductive line 2. Hence, an insulating layer (IL) is formed in overlapping portions to isolate the first conductive line 1 from the second conductive line 2. Then, connections are realized by connecting bridges through metal bridging. When touch screens are utilized in environments (such as in an electrostatic test or in daily use) in which the touch screens come into contact with static charges, signals transmitted between sensing circuits tend to be abnormal, especially when a high current is transmitted. Thus, bridging portions can very possibly break down due to electrostatic discharge (ESD) or the insulating layer in the overlapping portions is exploded to cause a short circuit or an open circuit between traces of the sensing circuits so as to affect touch screen performance.

In order to solve the above-mentioned problems, Chinese patent CN 103902092A published on Jul. 2, 2014 disclosed a touch screen. The touch screen comprises a first conductive line extended along a first direction. The first conductive line comprises a plurality of first sensing electrodes arranged at intervals along the first direction and a first connecting bridge connected between each of the two adjacent first sensing electrodes. Each of the first connecting bridges comprises a first sharp end. The touch screen further comprises an auxiliary discharging structure, which is insulated from the first conductive line and comprises second sharp ends. The second sharp end faces the first sharp end. The touch screen has a better anti-electrostatic interference ability. However, since the first sharp ends are disposed on the first connecting bridges, and the auxiliary discharging structure is further disposed and the second sharp ends are disposed on the auxiliary discharging structure, an area of metal lines which serve as connecting bridges is increased. In addition, the auxiliary discharging structure is disposed between sensing electrodes, which increases a length of the metal lines. As a result, the area of the metal lines is increased to significantly decrease an effective transmittance area of the sensing circuit. The transmittance of the screen is thus affected. In addition, the sharp ends and the auxiliary discharging structure render the overall structure of the touch screen to be complex, which in turn increases the difficulty in manufacturing and cost.

### SUMMARY OF THE INVENTION

It is an objective of the present invention to provide a capacitive sensing device, a touch screen and electronic equipment to not only effectively reduce a probability of occurrence of electrostatic discharge, but the structure is also simple and the transmittance is also higher.

An embodiment of the present invention provides a capacitive sensing device. The capacitive sensing device comprises a first conductive line extended along a first direction and a second conductive line extended along a second direction. The first conductive line is insulated from the second conductive line and the first conductive line and the second conductive line are disposed in an overlapping manner. The first conductive line comprises a plurality of first sensing electrodes arranged at intervals along the first direction and a first connecting bridge connected between each of the two adjacent first sensing electrodes. The second conductive line comprises a plurality of second sensing electrodes arranged at intervals along the second direction and a second connecting bridge connected between each of the two adjacent second sensing electrodes. The first sensing electrodes and the second sensing electrodes are staggered on a same plane. The second connecting bridges bypass the first connecting bridges to avoid a short circuit or an open circuit in overlapping portions because of an electrostatic discharge. Both the first connecting bridges and the second connecting bridges are smooth conductive lines.

Furthermore, a number of the second connecting bridges disposed between the two adjacent second sensing electrodes is at least one.

Furthermore, the second connecting bridge is in a shape of a curve.

Furthermore, the second connecting bridge is in a shape of a polyline.

Furthermore, the second connecting bridge comprises a first connecting portion, a second connecting portion and a third connection portion connected in sequence, the second connecting portion extends along the second direction, an independent area where the second connecting bridge passes through is divided from the first sensing electrode, the second connecting portion is disposed in the independent area and is isolated from the first sensing electrode.

Furthermore, the second connecting portions are made of a transparent conductive material.

Furthermore, the first direction is perpendicular to the second direction.

Furthermore, both the first sensing electrodes and the second sensing electrodes are in a shape of a diamond.

Another embodiment of the present invention provides a touch screen comprising a capacitive sensing device. The capacitive sensing device comprises a first conductive line extended along a first direction and a second conductive line extended along a second direction. The first conductive line is insulated from the second conductive line and the first conductive line and the second conductive line are disposed in an overlapping manner. The first conductive line comprises a plurality of first sensing electrodes arranged at intervals along the first direction and a first connecting bridge connected between each of the two adjacent first sensing electrodes. The second conductive line comprises a plurality of second sensing electrodes arranged at intervals along the second direction and a second connecting bridge connected between each of the two adjacent second sensing electrodes. The first sensing electrodes and the second sensing electrodes are staggered on a same plane. The second connecting bridges bypass the first connecting bridges to avoid a short circuit or an open circuit in overlapping portions because of an electrostatic discharge. Both the first connecting bridges and the second connecting bridges are smooth conductive lines.

Furthermore, a number of the second connecting bridges disposed between the two adjacent second sensing electrodes is at least one.

Furthermore, the second connecting bridge is in a shape of a curve.

Furthermore, the second connecting bridge is in a shape of a polyline.

Furthermore, the second connecting bridge comprises a first connecting portion, a second connecting portion and a third connection portion connected in sequence, the second connecting portion extends along the second direction, an independent area where the second connecting bridge passes through is divided from the first sensing electrode, the second connecting portion is disposed in the independent area and is isolated from the first sensing electrode.

Furthermore, the second connecting portions are made of a transparent conductive material.

Another embodiment of the present invention provides an electronic equipment comprising a touch screen with a capacitive sensing electrode. The capacitive sensing device comprises a first conductive line extended along a first direction and a second conductive line extended along a second direction. The first conductive line is insulated from the second conductive line and the first conductive line and the second conductive line are disposed in an overlapping manner The first conductive line comprises a plurality of first sensing electrodes arranged at intervals along the first direction and a first connecting bridge connected between each of the two adjacent first sensing electrodes. The second conductive line comprises a plurality of second sensing electrodes arranged at intervals along the second direction and a second connecting bridge connected between each of the two adjacent second sensing electrodes. The first sensing electrodes and the second sensing electrodes are staggered on a same plane. The second connecting bridges bypass the first connecting bridges to avoid a short circuit or an open circuit in overlapping portions because of an electrostatic discharge. Both the first connecting bridges and the second connecting bridges are smooth conductive lines.

Furthermore, a number of the second connecting bridges disposed between the two adjacent second sensing electrodes is at least one.

Furthermore, the second connecting bridge is in a shape of a curve.

Furthermore, the second connecting bridge is in a shape of a polyline.

Furthermore, the second connecting bridge comprises a first connecting portion, a second connecting portion and a third connection portion connected in sequence, the second connecting portion extends along the second direction, an independent area where the second connecting bridge passes through is divided from the first sensing electrode, the second connecting portion is disposed in the independent area and is isolated from the first sensing electrode.

Furthermore, the second connecting portions are made of a transparent conductive material.

Different from the prior art, the second connecting bridges bypass the first connecting bridges according to the present invention to avoid the crossing of the first connecting bridges and the second connecting bridges so as to avoid the electrostatic discharge phenomenon in the overlapping portions because of the concentrated signal charges. As a result, the insulating layer between the first conductive line and the second conductive line is prevented from breakdown or explosion to avoid the short circuit or open circuit in the overlapping portions. The stability of touch signal transmission is thus improved. Both the first connecting bridges and the second connecting bridges are smooth conductive lines to decrease the area of the conductive lines so as to increase the effective transmittance area of the sensing circuit. The transmittance of the screen is increased. In addition, the structure of the first connecting bridges and the second connecting bridges is simplified to reduce the difficulty in manufacturing and cost.

### BRIEF DESCRIPTION OF THE DRAWINGS

FIG. 1 is a schematic diagram showing a structure of a capacitive sensing device according to the prior art.

FIG. 2 is a schematic diagram showing a structure of a capacitive sensing device according to a first embodiment of the present invention.

FIG. 3 is a schematic diagram showing a structure of a capacitive sensing device according to a second embodiment of the present invention.

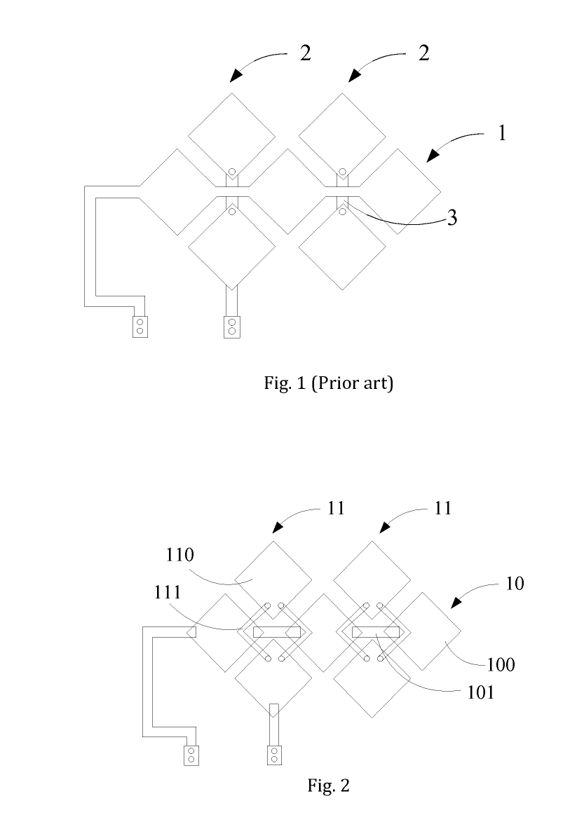

### DESCRIPTION OF THE EMBODIMENTS

The drawings illustrate embodiments of the invention and, together with the description, serve to explain the principles of the invention.

Refer to FIG. 2, FIG. 2 is a schematic diagram showing a structure of a capacitive sensing device according to a first embodiment of the present invention. The capacitive sensing device comprises a first conductive line 10 extended in a first direction and a second conductive line 11 extended in a second direction. The first conductive line 10 is insulated from the second conductive line 11 and the first conductive line 10 and the second conductive line 11 are disposed in an overlapping manner. The first direction is different from the second direction, for example, the first direction is perpendicular to the second direction according to the present embodiment.

The first conductive line 10 comprises a plurality of first sensing electrodes 100 arranged at intervals along the first direction and a first connecting bridge 101 connected between each of the two adjacent first sensing electrodes 100. The second conductive line 11 comprises a plurality of second sensing electrodes 110 arranged at intervals along the second direction and a second connecting bridge 111 connected between each of the two adjacent second sensing electrodes 110.

In greater detail, the first sensing electrodes 100 and the second sensing electrodes 110 are arranged in a matrix, and are staggered on a same plane. According to the present embodiment, both the first sensing electrodes 100 and the second sensing electrodes 110 are in a shape of a diamond. In the first direction, diagonals of the first sensing electrodes 100 in a same row are aligned along a same straight line. In the second direction, diagonals of the second sensing electrodes 110 in a same column are aligned along a same straight line. The first connecting bridge 101 connects two corners respectively of the two adjacent diamond-shaped first sensing electrodes 100. The first conductive line 10 may be made from a same material. For example, the first sensing electrodes 100 and the first connecting bridges 101 are both made of a transparent conductive material. The second sensing electrodes 110 may be made of a same material as the first sensing electrodes 100, which is the transparent conductive material, such as indium tin oxide (ITO) or aluminum doped zinc oxide (AZO). The second connecting bridges 111 may be metal conductive lines.

The second connecting bridges 111 bypass the first connecting bridges 101 to avoid generating overlapping portions by crossing the first connecting bridges 101. When static charges coming into contact with the touch screen, signals transmitted between sensing devices become abnormal. Especially, when a high current is transmitted, since signal charges in the first connecting bridges 101 and signal charges in the second connecting bridges 111 are more concentrated, the overlapping portions tend to break down or an insulating layer between the first connecting bridges 101 and the second connecting bridges 111 is exploded to cause a short-circuit or an open-circuit phenomenon. The touch performance is thus affected. According to the present invention, since the first connecting bridges 101 do not cross the second connecting bridges 111, no overlapping portion exists so as to avoid the overlapping of the two portions having concentrated signal charges. As a result, the probability of breakdown or explosion of the insulating layer is reduced to avoid a short circuit or an open circuit caused by an electrostatic discharge in the overlapping portions. Hence, the touch performance is improved. Additionally, the first connecting bridges 101 and the second connecting bridges 111 are both smooth conductive lines. There is no necessity to dispose another auxiliary structure. Not only is the touch performance improved, but an area of metal conductive lines is also not increased. A transmittance of the screen is not affected. In addition, smooth conductive lines have a simple structure, low difficulty in manufacturing and low cost.

A number of the second connecting bridges 111 disposed between the two adjacent second sensing electrodes 110 is at least one. As long as the second connecting bridges 111 can bypass the first connecting bridges 101, the second connecting bridges 111 may be in a shape of a continuous curve or a continuous polyline, or may be in a shape of segmented polylines. For example, the number of the second connecting bridges 111 disposed between the two adjacent second sensing electrodes 110 is two according to the present embodiment. The two second connecting bridges 111 are symmetrical to each other and are both in the shape of the continuous polyline. Disposing the two second connecting bridges 111 would ensure that when one of the routes is open circuited because of electrostatic discharge, the other route can transmit the touch signal so as to improve the quality of the sensing device. Additionally, dividing the line into two can achieve the effect of current sharing. Hence, when electrostatic discharge occurs to allow high current to pass through, the current is shared to reduce the probability and risk of breakdown.

Different from the prior art, the second connecting bridges bypass the first connecting bridges according to the present invention to avoid the crossing of the first connecting bridges and the second connecting bridges so as to avoid the electrostatic discharge phenomenon in the overlapping portions because of the concentrated signal charges. As a result, the insulating layer between the first conductive line and the second conductive line is prevented from breakdown or explosion to avoid the short circuit or open circuit in the overlapping portions. The stability of touch signal transmission is thus improved. Both the first connecting bridges and the second connecting bridges are smooth conductive lines to decrease the area of the conductive lines so as to increase the effective transmittance area of the sensing circuit. The transmittance of the screen is increased. In addition, the structure of the first connecting bridges and the second connecting bridges is simplified to reduce the difficulty in manufacturing and cost.

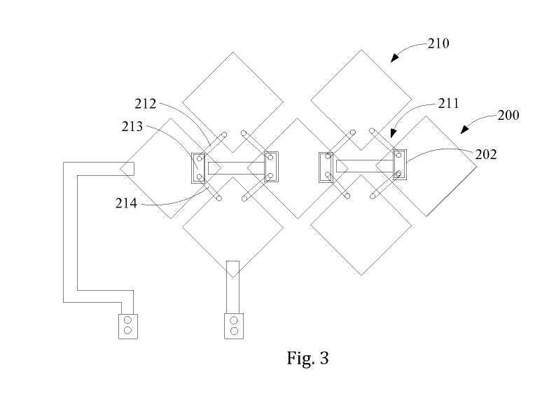

FIG. 3 is a schematic diagram showing a structure of a capacitive sensing device according to a second embodiment of the present invention.

A difference between the present embodiment and the first embodiment is that second connecting bridges 211 in the present embodiment are in the shape of the segmented polylines. The second connecting bridge 211 comprises a first connecting portion 212, a second connecting portion 213 and a third connection portion 214 connected in sequence. The second connecting portion 213 extends along the second direction. An independent area 202 where the second connecting bridge 211 passes through is divided from a first sensing electrode 200. The second connecting portion 213 is disposed in the independent area 202 and is isolated from the first sensing electrode 200. The second connecting bridge 211 connects two adjacent second sensing electrodes 210 through the first connecting portion 212, the second connecting portion 213 and the third connection portion 214 connected in sequence and bypass a first connection bridge. Hence, a short circuit or an open circuit caused by an electrostatic discharge in overlapping portions can be avoided to improve the touch performance At the same time, a position where the first connecting portion 212 is connected to the second sensing electrode 210 is disposed at a corner of the diamond-shaped second sensing electrode 210. The independent area 202 is disposed at a corner of the first sensing electrode 200 that is close to the two adjacent second sensing electrodes 210. A position where third connection portion 214 is connected to another second sensing electrode 210 is also at a corner of the another second sensing electrode 210. As a result, lengths of the second connecting portion 213 and the third connection portion 214 can be shortened to decrease an area of conductive lines. An effective transmittance area of the sensing circuit is increased to increase the transmittance of the screen. The second connecting bridges 211 may be metal conductive lines. In order to further increase the effective transmittance area of the sensing circuit, the second connecting portions 213 may be made of a transparent conductive material, such as a same material as the second sensing electrodes 210 to further shorten a length of the metal conductive lines utilized in the second connecting bridges 211. In this manner, the plane transmittance is not reduced on the basis of improved stability of touch operations.

The present invention further provides a touch screen. The touch screen comprises the above capacitive sensing device. In addition, the present invention still provides electronic equipment. The electronic equipment comprises the touch screen having the above capacitive sensing device. The touch screen has a good touch performance and stable signal transmission.

The capacitive sensing device, touch screen and electronic equipment according to the present invention use the smooth conductive lines to serve as the first connecting bridges and the second connecting bridges, and the first connecting bridges do not cross the second connecting bridges to avoid the short circuit or open circuit in the overlapping portions because of the electrostatic discharge. As a result, the stability of touch signal transmission is improved. At the same time, the area of the conductive lines is decreased and the effective transmittance area of the sensing circuit is increased to increase the transmittance of the screen. In addition, the structure of the first connecting bridges and the second connecting bridges is simplified to reduce the difficulty in manufacturing and cost.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A capacitive sensing device comprising a first conductive line extended along a first direction and a second conductive line extended along a second direction, the first conductive line being insulated from the second conductive line and the first conductive line and the second conductive line being disposed in an overlapping manner;
the first conductive line comprising a plurality of first sensing electrodes arranged at intervals along the first direction and a first connecting bridge connected between each of the two adjacent first sensing electrodes;
the second conductive line comprising a plurality of second sensing electrodes arranged at intervals along the second direction and a second connecting bridge connected between each of the two adjacent second sensing electrodes;
the first sensing electrodes and the second sensing electrodes being staggered on a same plane, the second connecting bridges bypassing the first connecting bridges to avoid a short circuit or an open circuit in overlapping portions because of an electrostatic discharge, both the first connecting bridges and the second connecting bridges being smooth conductive lines.

2. The capacitive sensing device as claimed in claim 1, wherein a number of the second connecting bridges disposed between the two adjacent second sensing electrodes is at least one.

3. The capacitive sensing device as claimed in claim 1, wherein the second connecting bridge is in a shape of a curve.

4. The capacitive sensing device as claimed in claim 1, wherein the second connecting bridge is in a shape of a polyline.

5. The capacitive sensing device as claimed in claim 1, wherein the second connecting bridge comprises a first connecting portion, a second connecting portion and a third connection portion connected in sequence, the second connecting portion extends along the second direction, an independent area where the second connecting bridge passes through is divided from the sensing electrode, the second connecting portion is disposed in the independent area and is isolated from the first sensing electrode.

6. The capacitive sensing device as claimed in claim 5, wherein the second connecting portions are made of a transparent conductive material.

7. The capacitive sensing device as claimed in claim 1, wherein the first direction is perpendicular to the second direction.

8. The capacitive sensing device as claimed in claim 1, wherein both the first sensing electrodes and the second sensing electrodes are in a shape of a diamond.

9. A touch screen comprising a capacitive sensing electrode, the capacitive sensing device comprising a first conductive line extended along a first direction and a second conductive line extended along a second direction, the first conductive line being insulated from the second conductive line and the first conductive line and the second conductive line being disposed in an overlapping manner;
the first conductive line comprising a plurality of first sensing electrodes arranged at intervals along the first direction and a first connecting bridge connected between each of the two adjacent first sensing electrodes;
the second conductive line comprising a plurality of second sensing electrodes arranged at intervals along the second direction and a second connecting bridge connected between each of the two adjacent second sensing electrodes;
the first sensing electrodes and the second sensing electrodes being staggered on a same plane, the second connecting bridges bypassing the first connecting bridges to avoid a short circuit or an open circuit in overlapping portions because of an electrostatic discharge, both the first connecting bridges and the second connecting bridges being smooth conductive lines.

10. The touch screen as claimed in claim 9, wherein a number of the second connecting bridges disposed between the two adjacent second sensing electrodes is at least one.

11. The touch screen as claimed in claim 9, wherein the second connecting bridge is in a shape of a curve.

12. The touch screen as claimed in claim 9, wherein the second connecting bridge is in a shape of a polyline.

13. The touch screen as claimed in claim 9, wherein the second connecting bridge comprises a first connecting portion, a second connecting portion and a third connection portion connected in sequence, the second connecting portion extends along the second direction, an independent area where the second connecting bridge passes through is divided from the first sensing electrode, the second connecting portion is disposed in the independent area and is isolated from the first sensing electrode.

14. The touch screen as claimed in claim 13, wherein the second connecting portions are made of a transparent conductive material.

15. An electronic equipment comprising a touch screen with a capacitive sensing electrode, the capacitive sensing device comprising a first conductive line extended along a first direction and a second conductive line extended along a second direction, the first conductive line being insulated from the second conductive line and the first conductive line and the second conductive line being disposed in an overlapping manner;
the first conductive line comprising a plurality of first sensing electrodes arranged at intervals along the first direction and a first connecting bridge connected between each of the two adjacent first sensing electrodes;
the second conductive line comprising a plurality of second sensing electrodes arranged at intervals along the second direction and a second connecting bridge connected between each of the two adjacent second sensing electrodes;
the first sensing electrodes and the second sensing electrodes being staggered on a same plane, the second connecting bridges bypassing the first connecting bridges to avoid a short circuit or an open circuit in overlapping portions because of an electrostatic discharge, both the first connecting bridges and the second connecting bridges being smooth conductive lines.

16. The electronic equipment as claimed in claim 15, wherein a number of the second connecting bridges disposed between the two adjacent second sensing electrodes is at least one.

17. The electronic equipment as claimed in claim 15, wherein the second connecting bridge is in a shape of a curve.

18. The electronic equipment as claimed in claim 15, wherein the second connecting bridge is in a shape of a polyline.

19. The electronic equipment as claimed in claim 15, wherein the second connecting bridge comprises a first connecting portion, a second connecting portion and a third connection portion connected in sequence, the second connecting portion extends along the second direction, an independent area where the second connecting bridge passes through is divided from the first sensing electrode, the second connecting portion is disposed in the independent area and is isolated from the first sensing electrode.

20. The electronic equipment as claimed in claim 19, wherein the second connecting portions are made of a transparent conductive material.
